(19) United States
(12) Patent Application Publication
(10) Pub. No.: US 2026/0302454 A1
(43) Pub. Date: Oct. 1, 2026

(54) SECONDARY BATTERY AND METHOD FOR MANUFACTURING SAME

(71) Applicant: SAMSUNG SDI CO., LTD., Yongin-si (KR)

(72) Inventor: Jun Sung AHN, Yongin-si (KR)

(21) Appl. No.: 19/463,970

(22) Filed: Jan. 29, 2026

(30) Foreign Application Priority Data
Mar. 25, 2025 (KR) 10-2025-0038016

(51) Int. Cl. H01M 50/184; H01M 50/105; H01M 50/121

(52) U.S. Cl. CPC H01M 50/184; H01M 50/105; H01M 50/121

(57) ABSTRACT

The present disclosure relates to a secondary battery and a method for manufacturing same. The secondary battery comprises may include an electrode assembly and a case accommodating the electrode assembly, wherein the case includes a case body that forms a space in which the electrode assembly is accommodated and a case cover that seals an upper side of the case body, and sealing parts positioned on both sides in the width direction of the case body and the case cover may be sealed in a state of being inwardly folded to the interior of the case.

### CROSS-REFERENCE TO RELATED APPLICATION

The present application claims priority to and the benefit of Korean Patent Application No. 10-2025-0038016, filed on Mar. 25, 2025, in the Korean Intellectual Property Office, the entire disclosure of which is incorporated herein by reference

### BACKGROUND

### 1. Field

The present disclosure relates to a secondary battery and a method for manufacturing same.

### 2. Description of the Related Art

Unlike a primary battery that cannot be charged, a secondary battery is a rechargeable and dischargeable battery. A low-capacity secondary battery may be used for various portable small-sized electronic devices, such as a smartphone, a feature phone, a notebook computer, a digital camera, or a camcorder, and a high-capacity secondary battery is widely used as a power source for motor drives, such as those in hybrid vehicles or electric vehicles. The secondary battery includes an electrode assembly consisting of a positive electrode and a negative electrode, a case accommodating the same, and electrode terminals connected to the electrode assembly.

The above information disclosed in this Background section is only for enhancement of understanding of the background of the disclosure and therefore it may contain information that does not constitute prior art.

### SUMMARY

Embodiments of the present disclosure are directed to a secondary battery and a method for manufacturing same, which are configured for enhancing the reliability of the secondary battery by inwardly folding a sealing part to increase the internal space utilization of a case and prevent or reduce sealing damage due to external impacts and vibrations.

Some embodiments of the present disclosure are directed to a secondary battery and a method for manufacturing same, which are configured for strengthening the sealing performance of a case accommodating an electrode assembly and stably maintaining the folding of a sealing part and sealing quality during a manufacturing process, by improving structural characteristics of the case.

However, the technical problems to be achieved in the embodiment of the disclosure are not limited to the technical problems mentioned above, and other technical problems not mentioned herein will be clearly understood from the following description by those skilled in the art to which the disclosure belongs.

An exemplary secondary battery according to one embodiment of the present disclosure may include an electrode assembly and a case accommodating the electrode assembly, wherein the case includes a case body that forms a space in which the electrode assembly is accommodated and a case cover on an upper side of the case body, and a sealing part on a first side and a second side in the width direction of the case body and the case cover inwardly folded to the interior of the case for being sealed.

In some examples, the sealing part may be positioned between the electrode assembly and the inner wall of the case body.

In some examples, the sealing part may be formed by inwardly folding a first edge and a second edge in the width direction of the case, wherein the case cover is in contact with the case body.

In some examples, the case body and the case cover may be formed of a polymer film.

In some examples, the sealing part includes an adhesive reinforcing agent on the inwardly folded portion of the sealing part, wherein the adhesive reinforcing agent is configured to be cured after the case body and the case cover are sealed.

In some examples, the sealing part may include a first adhesion part positioned on the first side in the width direction of the case and a second adhesion part positioned on the second side in the width direction of the case.

In some examples, the first adhesion part may include a first body side positioned on the first side in the width direction of the case body and a first cover side positioned on the first side in the width direction of the case cover.

In some examples, the first body side and the first cover side may be inwardly folded to the interior of the case for being sealed.

In some examples, the second adhesion part may include a second body side positioned on the second side in the width direction of the case body and a second cover side positioned on the second side in the width direction of the case cover.

In some examples, the second body side and the second cover side may be inwardly folded to the interior of the case and for being sealed.

In some examples, the first adhesion part and the second adhesion part may be inwardly folded once to the interior of the case.

In some examples, the first adhesion part and the second adhesion part may be inwardly folded twice to the interior of the case.

An exemplary method for manufacturing a secondary battery according to one embodiment of the present disclosure for solving the above technical problem may include: preparing a case comprising a case body accommodating an electrode assembly and a case cover sealing upper side of the case body; inwardly folding to the interior of the case, a first side of the case body and the case cover and a second side of the case body and the case cover, wherein the first side and the second side are in the width direction of the case body and the case cover; sealing the inwardly folded first side of the case body and the case cover and the inwardly folded second side of the case body and the case cover and forming a sealing part; and inserting the electrode assembly through an opening part of the case and sealing the opening part.

In some examples, the case body and case cover may be made of a polymer film, and the sealing part may be sealed through a heat-compression method.

In some examples, the sealing part may be sealed by using ultrasonic vibration.

In some examples, the forming of the sealing part may include applying an adhesive reinforcing agent to the inwardly folded first side and the inwardly folded second side, and curing the adhesive reinforcing agent to additionally seal the case.

In some examples, the inwardly folding the first side and the second side may include folding the first side and the second side once, and refolding the folded first side and the folded second side.

In some examples, the preparing the case body and the case cover may include forming a structure in which the case cover is integrally connected to the case body.

In some examples, the sealing the opening part after inserting the electrode assembly into the opening part of the case may include sealing the opening part by a pressing method using a hot plate and a roller.

In some examples, the inwardly folding the first side and the second side may include controlling a folding angle of the first side and the second side to be maintained in a range from approximately 90 degrees to approximately 270 degrees.

In some examples, the inwardly folding the first side and the second side may include folding, to the inside of the case, a first body side positioned on the first side in the width direction of the case body and a first cover side positioned on the first side of the width direction of the case cover, respectively.

In some examples, the inwardly folding may include folding, to the inside of the case, a second body side positioned on the second side in the width direction of the case body and a second cover side positioned on the second side in the width direction of the case cover.

According to an embodiment of the present disclosure, by sealing the sealing parts positioned on both sides in the width direction of the case in a state of being inwardly folded, the utilization of the internal space of the case is increased, thereby reducing the external size of battery and implementing a high-capacity and miniaturized secondary battery.

In addition, by inwardly folding the sealing parts, damage to the sealing parts due to external impact and vibration can be prevented, and the sealability of the case can be strengthened.

However, the effects achievable through the present invention are not limited to those described above, and other technical effects not mentioned can be clearly understood by those skilled in the art from the description of the invention provided above.

### BRIEF DESCRIPTION OF THE DRAWINGS

The following drawings attached to this specification illustrate preferred embodiments of the present disclosure, and serve to further understand the technical idea of the present disclosure together with the detailed description of the present disclosure, and thus, the present disclosure should not be construed as being limited to the matters described in such drawings.

FIG. 1 is an exploded perspective view of a secondary battery according to an embodiment of the present disclosure.

FIG. 2 is a perspective view of a secondary battery according to an embodiment of the present disclosure.

FIG. 3 is a cross-sectional view of a case body separated from a case cover, according to an embodiment of the present disclosure, are separated.

FIG. 4 is a cross-sectional view of a case body and a case cover with infolded edges on both sides of the case body and the case cover in the width direction according to an embodiment of the present disclosure.

FIG. 5 is a cross-sectional view of a first adhesion part and a second adhesion part positioned inside a case, according to an embodiment of the present disclosure.

FIG. 6 is a cross-sectional view of a first adhesion part and a second adhesion part inwardly folded to the interior of the case, according to an embodiment of the present disclosure.

FIG. 7 is a cross-sectional view of a first adhesion part and a second adhesion part are folded and refolded, according to an embodiment of the present disclosure.

FIG. 8 is a cross-sectional view of a first adhesion part and a second adhesion part in a refolded state that are in contact with the inside of a case, according to an embodiment of the present disclosure.

FIG. 9 is a cross-sectional view of a case body separated from a case cover, according to an embodiment of the present disclosure.

FIG. 10 is a cross-sectional view of a case body and a case cover folded on a first side and a second side in the width direction, according to an embodiment of the present disclosure.

FIG. 11 is a cross-sectional view of a first adhesion part and a second adhesion part positioned inside a case, according to an embodiment of the present disclosure.

FIG. 12 is a cross-sectional view of a first adhesion part and a second adhesion part inwardly folded to the interior of a case, according to an embodiment of the present disclosure.

FIG. 13 is a flowchart of a method for manufacturing a secondary battery according to an embodiment of the present disclosure.

FIGS. 14 and 15 are perspective views of a battery pack including an exemplary secondary battery according to an embodiment of the present disclosure.

FIGS. 16 and 17 are, respectively, a perspective view and a side view of vehicles including an exemplary battery pack according to an embodiment of the present disclosure.

### DETAILED DESCRIPTION

Hereinafter, the present disclosure will be described in detail. Prior to giving the following detailed description of the present disclosure, it should be noted that the terms and words used in the specification and the claims should not be construed as being limited to ordinary meanings or dictionary definitions but should be construed in a sense and concept consistent with the technical idea of the present disclosure, on the basis that the inventor can properly define the concept of a term to describe the disclosure in the best way possible. Therefore, the embodiments described in the specification and the configurations described in the drawings are only the most preferred embodiments of the present disclosure, and do not represent all of the technical ideas of the present disclosure. It is to be understood that there may be various equivalents and variations in place of them at the time of filing the present application. In addition, as used herein, the terms “comprise or include” and/or “comprising or including,” when used in this specification, specify the presence of stated features, numbers, steps, operations, elements, and/or components, but do not preclude the presence or addition of one or more other features, numbers, steps, operations, elements, components, and/or groups thereof. In addition, when describing embodiments of the present disclosure, “can” and “may” may include “one or more embodiments of the present disclosure.”

In addition, for a better understanding of the invention, the attached drawings are not drawn to scale and the dimensions of some components may be exaggerated. In addition, the same reference numbers may be assigned to the same components in different embodiments.

A reference to two objects in comparison being the same means that they are substantially the same. Thus, the wording “substantially the same” may include cases where the same is considered to be a low level in the related art, for example, a deviation within 5%. In addition, when any of parameters is referred to as being uniform in a given region, it may mean that the parameter is uniform from an average perspective.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, unless otherwise defined, a first element, component, region, layer or section described below could be termed a second element, component, region, layer or section, without departing from the spirit and scope of the present disclosure.

Throughout the specification, each component may be singular or plural, unless the context clearly indicates otherwise.

The arrangement of an arbitrary component on the “upper portion (or lower portion)” or “upper (or lower) portion” of a component means that an arbitrary component is placed in contact with the upper (or lower) surface of the component. In addition, it may mean that other components may be interposed between the component and any component disposed on (or under) the component.

Also, it will be understood that when an element is referred to as being “connected to,” “coupled to,” or “linked to” another element, these elements can be directly connected or coupled to each other, another intervening element may be present therebetween, or the respective elements may be connected, coupled, or linked to each other through another elements.

Throughout the specification, the expression “A and/or B” means A, B, or A and B, unless otherwise defined. That is, as used herein, the term “and/or” includes any and all combinations of one or more of the associated listed items. The expression “C to D” means C or more and D or less, unless otherwise defined.

As used herein, the terms are for describing embodiments of the present disclosure and are not intended to limit the disclosure.

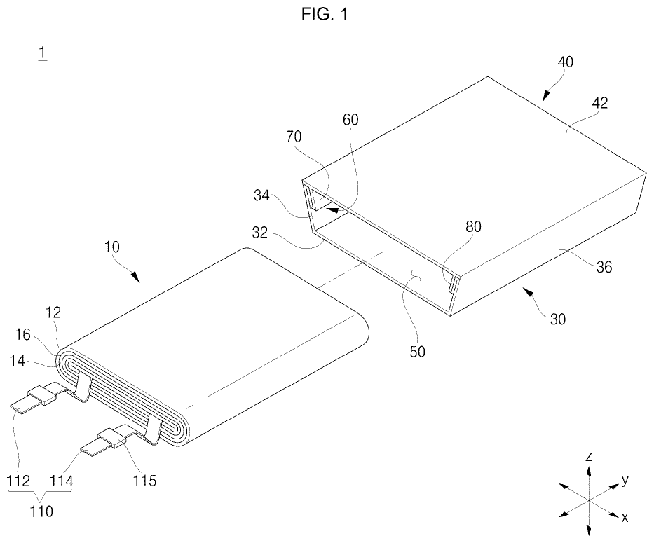

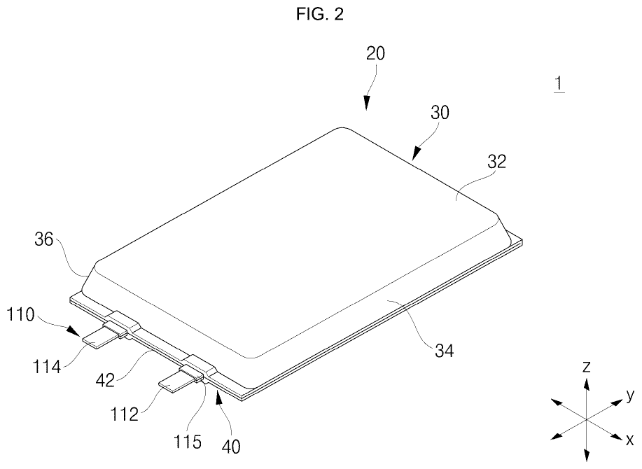

FIG. 1 is an exploded perspective view of a secondary battery 1 according to an embodiment of the present disclosure. FIG. 2 is a perspective view of the secondary battery 1 according to an embodiment of the present disclosure. As shown in FIGS. 1 and 2, the secondary battery 1 according to an embodiment of the present disclosure may include an electrode assembly 10, a case 20, and a sealing part 60. In some embodiments, the secondary battery 1 may further include an electrode lead 110 and an insulating tape 115.

As to the definition of directions, the length direction is defined as y, the width direction that intersects perpendicularly with the length direction (y) is defined as x, and the up-down direction that intersects perpendicularly with the length direction (y) and the width direction (x) is defined as z. The length direction (y) may be referred to as a first direction, the width direction (x) may be referred to as a second direction, and the up-down direction (z) may be referred to as a third direction.

The present disclosure relates to a technology for maximizing the utilization of the internal space of battery by inwardly folding the sealing part 60 and improving the reliability of the secondary battery 1 by preventing or reducing sealing damage due to external impacts and vibrations. The secondary battery 1 according to an embodiment of the present disclosure includes an electrode assembly 10 and a case 20 that accommodates the electrode assembly 10, and the case 20 includes a case body 30 that forms a space in which the electrode assembly 10 is accommodated, and a case cover 40 that closes the upper side of the case body 30. The case body 30 and the case cover 40 may be formed of a polymer film, and with a lightweight structure, miniaturization and high capacity of the battery can be achieved.

The sealing part 60 positioned on both sides (e.g., a first side and a second side) in the width direction (x) of the case body 30 and the case cover 40 is configured to be inwardly folded (e.g., infolded, inwardly bent, or creased inward) toward the case 20 (e.g., during assembly). The folded structure or configuration helps enhance the airtightness and durability of the battery. In some embodiments, the sealing part 60 is positioned between the electrode assembly 10 and the inner wall of the case body 30, enabling an increase in capacity in a battery of the same size. In some embodiments, an adhesive reinforcing agent 90 is included to further increase sealing strength and help provide long-term airtightness. Accordingly, the present disclosure may provide high performance and reliability in a variety of applications, including small electronic devices, electric vehicles, and energy storage systems.

In some embodiments, the case 20 accommodates the electrode assembly 10 and is designed to maintain airtightness with the electrode lead 110 drawn out to the outside of the case. The case 20 is installed in a shape that wraps around the outside of the electrode assembly 10 and may be transformed into various shapes. In an embodiment of the present disclosure, the case 20 may use a pouch made of a soft film, and the pouch may form a case body 30 and a case cover 40 by folding a rectangular film extending in a first direction (y). The case body 30 and the case cover 40 may be composed of a polymer film, and through weight reduction, miniaturization and high capacity of battery can be achieved.

In an embodiment of the present disclosure, the case 20 is not limited to an integral structure in which the case body 30 and the case cover 40 are formed on a single film, and various modifications are possible, such as being configured as separate members. For convenience, the following description is based on an example in which the case body 30 and the case cover 40 are formed on a single rectangular film.

The case body 30 may be transformed into various shapes within the technical concept of forming a space in which the electrode assembly 10 is accommodated. The sealing part 60 may be provided on both sides in the width direction (x) of the case body 30. One side of the case body 30 in the length direction (y) is connected to the case cover 40, and the other side in the length direction (y) is provided with an opening part 50 into which the electrode assembly 10 is inserted.

The case body 30 and the case cover 40 may be multilayer thin films formed of a metal thin film and an insulating layer formed on one surface and the other surface thereof, and this structure provides electrical insulation and improves the stability of the battery. The case body 30 may be manufactured to a size capable of accommodating the electrode assembly 10 through pressing or drawing processing. In the present embodiment, the case body 30 is composed of a base surface 32, a first body side surface 34, and a second body side surface 36.

The base surface 32 forms the lower portion of the case body 30 and has a planar structure. One side of the base surface 32 may be connected to the case cover 40. The first body side surface 34 and the second body side surface 36 are respectively positioned on both sides in the width direction (x) of the base surface 32, and these extend upwardly from the base surface 32 to form a structure that surrounds the electrode assembly 10.

The first body side surface 34 and the second body side surface 36 are formed in a shape that is curved upward on both sides in the width direction (x), and the upper end may be folded in a horizontal direction to form a plane facing the case cover 40.

The case cover 40 has a rectangular flat plate shape and, when combined with the case body 30, closes the space where the electrode assembly 10 is accommodated. The case cover 40 effectively blocks the upper portion of the case body 30 through a folding motion, reducing external impact and environmental influences.

The case body 30 and the case cover 40 are fixed to the sealing part 60 on both sides in the width direction (x), one side in the length direction (y) is connected to the case cover 40, and the other side in the length direction (y) forms the opening part 50. The opening part 50 is used as an insertion path for the electrode assembly 10 and the electrolyte, and is sealed after assembling to provide reliability and airtightness of battery.

The sealing part 60 is positioned on both edges in the width direction (x) of the case body 30 and the case cover 40, and is formed by inwardly folding toward the case 20. Generally, a structure in which the sealing part 60 protrudes outwardly from the case 20 may increase the external size and reduce space utilization, but the sealing part 60 of an embodiment of the present disclosure is designed to inwardly fold toward the case 20, thereby overcoming this drawback.

By inwardly folding the sealing part 60, the volume previously occupied by the outside of the case 20 is reduced, enabling efficient use of the internal space in the secondary battery 1 of the same external size. This allows for an increase in the capacity of the electrode assembly 10 and the electrolyte, effectively increasing the capacity of the secondary battery 1.

The sealing part 60 is formed by inwardly folding the edge of the case 20 in the width direction (x), where the case cover 40 and the case body 30 are in contact with each other, and is processed by heat compression or ultrasonic vibration, thereby increasing or ensuring airtightness. In some embodiments, the sealing part 60 has a single-fold or double-fold structure, and prevents or reduces damage caused by external impact or vibration and strengthens internal airtightness. The sealing part 60 according to one embodiment of the present disclosure is divided into a first adhesion part 70 and a second adhesion part 80, which are respectively positioned on one side (a first side) and the other side (a second side) in the width direction (x) of the case 20.

The first adhesion part 70 is positioned on one edge in the width direction (x) of the case 20, and is formed by inwardly folding one-side (first) edges in the width direction (x) of the case body 30 and case cover 40. The first adhesion part 70 is fixed by the folded sealing part 60 being in close contact with the inner surface of the case 20, thereby ensuring the airtightness of the internal space of the case 20.

In some embodiments, the folding structure or configuration of the sealing part 60 allows for optimization of the internal space of the case 20 without externally protruding portions, which leads to the arrangement of the electrode assembly 10 and increased electrolyte capacity, thereby improving the performance of the secondary battery 1. In some embodiments, the adhesive reinforcing agent 90 may be applied to the inside of a bonded portion, and the adhesive reinforcing agent 90 may be cured to secure additional airtightness and stability.

The second adhesion part 80 is positioned on the other edge in the width direction (x) of the case 20, and is formed by inwardly folding the other (second) edges in the width direction (x) of the case body 30 and the case cover 40. The second adhesion part 80 may be fixed in the same manner as the first adhesion part 70 to further enhance the airtightness inside the case 20.

With the inwardly folded structure, the external size of case 20 may be reduced, the utilization of internal space may be increased, and the electrode assembly 10 and the electrolyte may be additionally placed, to help increase battery capacity. In some embodiments, the long-term reliability of the bonded portion can be secured by utilizing the adhesive reinforcing agent 90. The first adhesion part 70 and the second adhesion part 80 are positioned inside the case 20 and extend along the length direction (y) of the case 20.

The electrode assembly 10 may be formed by winding a first electrode plate 12, a second electrode plate 14, and a separator 16. The electrode assembly 10 may be implemented in a roll shape (winding type) or a stack type structure.

The electrode assembly 10 according to one embodiment of the present disclosure is accommodated in the case 20, which may be referred to as a pouch. The electrode assembly 10 has a structure in which the separator 16 is disposed between the first electrode plate 12 and the second electrode plate 14, and electrode tabs are formed in one direction.

The electrode assembly 10 may be accommodated inside the case 20 together with an electrolyte. The electrolyte may be composed of a combination of an organic solvent and a lithium salt. Examples of the organic solvent that can be used include ethylene carbonate (EC), propylene carbonate (PC), diethyl carbonate (DEC), ethyl methyl carbonate (EMC), and dimethyl carbonate (DMC). Examples of the lithium salt that can be used include LiPF6 and LiBF4, and the electrolyte is appropriately composed considering electrical and chemical reactivity with an electrode.

The first electrode plate 12 has a plate-shaped structure made of aluminum (Al). The first electrode plate 12 functions as a positive electrode plate that accommodates a positive electrode active material, and an electrode tab may be connected to the first electrode plate 12.

The second electrode plate 14 has a plate-shaped structure made of copper (Cu) or nickel (Ni). The second electrode plate 14 functions as a negative electrode plate that accommodates a negative electrode active material, and is wound together with the first electrode plate 12 to form the electrode assembly 10. An electrode tab may be connected to the second electrode plate 14.

The separator 16 is disposed between the electrode plates to prevent electrical short circuits and only allow the movement of lithium ions. The material of the separator 16 may be polyethylene (PE) or polypropylene (PP), but is not limited thereto. The separator 16 may be implemented with various porous structures to ensure the efficiency and safety of an electrochemical reaction.

The electrode lead 110 is a member that connects the electrode tab electrically connected to the electrode assembly 10 to an external circuit or terminal, and serves to transmit current. One side of the electrode lead 110 is electrically connected to the electrode tab of the electrode assembly 10, and the other side extends to the outside of the case 20 and may be electrically connected to an external terminal. The electrode lead 110 may be made of a metal material having high conductivity and low internal resistance (e.g., aluminum, copper, or an alloy thereof), and a multilayer structure or plating treatment can be applied to reinforce mechanical strength and durability as needed. In one embodiment of the present disclosure, the electrode lead 110 may include a positive electrode lead 112 electrically connected to the first electrode plate 12 and a negative electrode lead 114 electrically connected to the second electrode plate 14.

The insulating tape 115 is a member for electrical insulation between the electrode lead 110 and the case 20, and may be installed outside the electrode lead 110. The insulating tape 115 may be composed of a flexible yet durable material (e.g., polyethylene (PE), polyimide (PI), polypropylene (PP), etc.).

The insulating tape 115 may improve battery safety by blocking the electrical connection between the electrode lead 110 and the case 20, and may prevent short circuits caused by external electrical interference. In some examples, by optimizing the thickness or arrangement of the insulating tape 115, the sealing performance of the case 20 may also be improved.

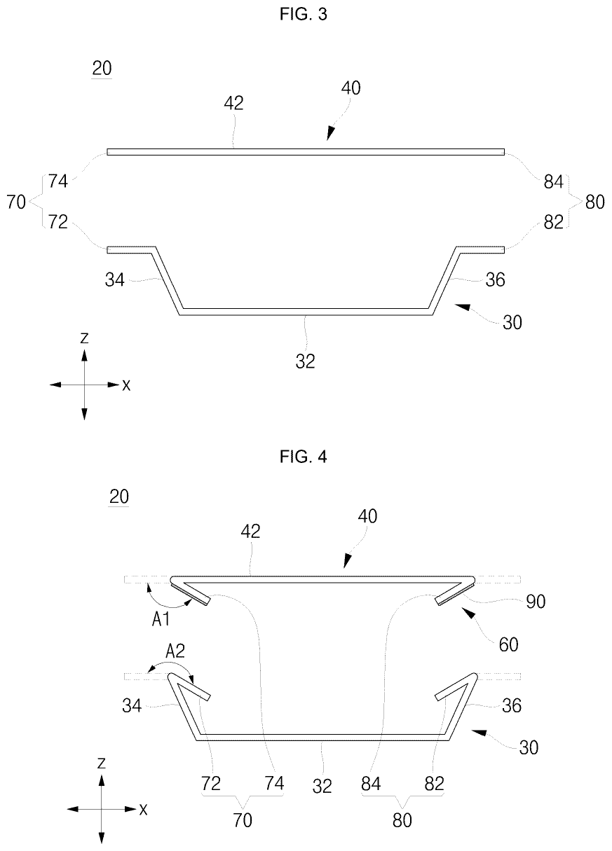

FIG. 3 is a cross-sectional view of the case body 30 separated from the case cover 40, according to an embodiment of the present disclosure. FIG. 4 is a cross-sectional view of the case body 30 and the case cover 40 with infolded edges on both sides of the case body and the case cover in the width direction (x) according to an embodiment of the present disclosure. As shown in FIGS. 3 and 4, the case cover 40 is positioned on the upper side of the case body 30 and may cover the electrode assembly 10.

One (first) side or edge in the width direction (x) of the case body 30 and the case cover 40 may be sealed to form the first adhesion part 70. In some examples, the first adhesion part 70 may include a first body side 72 positioned on one (first) side or edge in the width direction (x) of the case body 30 and a first cover side 74 positioned on one (first) side or edge in the width direction (x) of the case cover 40.

The first body side 72 is positioned on one (first) side in the width direction (x) of the case body 30 and may refer to a portion extending horizontally from the top of the first body side surface 34. The first cover side 74 refers to a portion of the cover surface 42 that forms the body of the case cover 40 facing the first body side 72 and is positioned on one side in the width direction (x) of the cover surface 42.

The first body side 72 and the first cover side 74 may be inwardly folded to the interior of the case 20 to form infolded edges, and sealed to each other to form the first adhesion part 70. The sealing may be performed by using a heat-sealing layer formed on the inner surface of the case 20 made of a heat-sealing material.

The other (second) side or edge in the widthwise direction (x) of the case body 30 and case cover 40 may be sealed to form the second adhesion part 80. In some examples, the second adhesion part 80 may include a second body side 82 positioned on the other (second) side or edge in the widthwise direction (x) of the case body 30 and a second cover side 84 positioned on the other (second) side in the widthwise direction (x) of the case cover 40.

The second body side 82 is positioned on the other (second) side in the width direction (x) of the case body 30, and may refer to a portion extending horizontally from the top of the second body side surface 36. The second cover side 84 refers to a portion of the cover surface 42 that forms the body of the case cover 40 facing the second body side 82, and is positioned on the other side in the width direction (x) of the cover surface 42.

The second body side 82 and the second cover side 84 may be inwardly folded to the interior of the case 20 to form infolded edges, and sealed to each other to form the second adhesion part 80. Since both the first adhesion part 70 and the second adhesion part 80 are inwardly folded to the interior of the case 20, the space utilization of the outside of the case 20 can be increased and the capacity of the secondary battery 1 can be increased.

In some examples, the sealing part 60 may be additionally sealed by curing the adhesive reinforcing agent 90 applied to the inside of the folded portion of the sealing part 60 after the case body 30 and the case cover 40 are sealed. Even before sealing, the adhesive reinforcing agent 90 may be applied in advance to the portion to be sealed and used.

The adhesive reinforcing agent 90 may be applied to at least one facing surface of the first body side 72 and the first cover side 74 positioned on one side in the width direction (x) of the case body 30 and the case cover 40. In some embodiments, the adhesive reinforcing agent 90 may also be applied to at least one facing surface of the second body side 82 and the second cover side 84 positioned on the other side in the width direction (x).

In some embodiments, in a state in which the sealing part 60 is formed inside the case 20, the sealability of the sealing part 60 can be further strengthened by applying the adhesive reinforcing agent 90 to the inside of the sealing part 60. The adhesive reinforcing agent 90 may compensate for micro-gaps that may occur due to folding of the sealing part 60, thereby improving the durability and reliability of the battery 1.

The sealing part 60 can be designed and controlled so that the folding angle (A1, A2) is maintained to be in a range from approximately 90 degrees to approximately 270 degrees.

The cover side folding angle (A1) refers to the angle at which the first cover side 74 and the second cover side 84, which are the edges on both sides of the width direction (x) of the case cover 40, are inwardly folded to the interior of the case 20 on the basis of the cover surface 42. The first cover side 74 and the second cover side 84 are rotated by the folding angle (A1) around or about the cover surface 42 and inwardly folded to the interior of the case 20, and come into close contact with the case cover 40. The cover side folding angle (A1) can be controlled within a range of about 90 degrees to about 270 degrees.

The body side folding angle (A2) refers to the angle at which the first body side 72 and the second body side 82, which are the sides in the width direction (x) of the case body 30, are inwardly folded to the interior of the case 20 with respect to the base surface 32. The first body side 72 and the second body side 82 are inwardly folded to the interior of the case 20 by rotating by the folding angle (A2) with respect to the base surface 32. The body side folding angle (A2) can be controlled within a range of about 90 degrees to about 270 degrees.

These folding angles (A1, A2) can contribute to increasing the space utilization of the sealing part 60, preventing or reducing unnecessary protrusion on the outside of the case 20, and increasing the stability of the sealing part 60. In some embodiments, the folding angles (A1, A2) help increase the utilization of the internal space of the case 20 by stably inwardly folding the case body 30 and the case cover 40 and sealing the same tightly, and through appropriate control of the folding angles (A1, A2), the airtightness and structural durability of the sealing part 60 can be further improved.

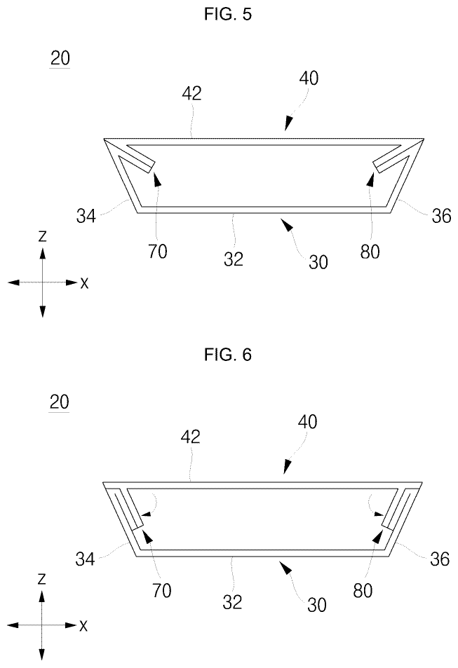

FIG. 5 is a cross-sectional view of the first adhesion part 70 and the second adhesion part 80 positioned inside the case 20, according to an embodiment of the present disclosure. As shown in FIG. 5, a first side in the width direction (x) of the case body 30 and a first side in the width direction (x) of the case cover 40 are adhered and sealed to each other on the inside of the case 20 to form the first adhesion part 70. In some embodiments, a second side opposite to the first side in the width direction (x) of the case body 30 and a second side opposite to the first side in the width direction (x) of the case cover 40 are adhered and sealed to each other on the inside of the case 20 to form the second adhesion part 80.

FIG. 6 is a cross-sectional view of the first adhesion part 70 and the second adhesion part 80 are inwardly folded to the interior of the case 20, according to an embodiment of the present disclosure. As shown in FIG. 6, the first adhesion part 70 and the second adhesion part 80 are inwardly folded to contact the interior of the case body 30, to improve the space utilization inside the case 20. In some embodiments, the first adhesion part 70 may be rotated and positioned in contact with the inside of the first body side surface 34, and the second adhesion part 80 may be rotated and positioned in contact with the inside of the second body side surface 36.

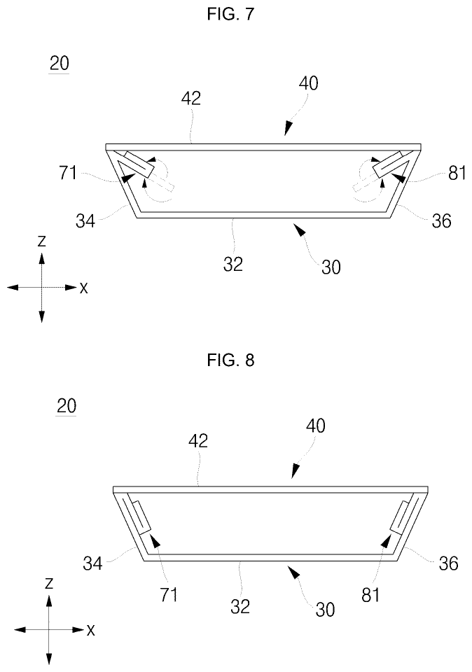

FIG. 7 is a cross-sectional view of the first adhesion part 71 and the second adhesion part 81 that have been folded twice (e.g., folded once and then refolded) to produce a double infolded structure, according to an embodiment of the present disclosure. FIG. 8 is a cross-sectional view of the first adhesion part 71 and the second adhesion part 81 in contact with the inside of the case 20 while being in the refolded state, according to an embodiment of the present disclosure.

As shown in FIGS. 7 and 8, the sealing part 60 may be folded and then refolded in the same direction after being inwardly folded once to the case 20. The double folding method is designed to more efficiently arrange the folding structure of the first adhesion part 71 and the second adhesion part 81 in the internal space formed by the case body 30 and the case cover 40. Through this, the sealing part 60 may be arranged in close contact with the internal space of the case 20 even in the folded state, and the bonding force with the internal surface of the case 20 can be increased.

In some embodiments, the double folding is designed to more stably fix the edges in the width direction (x) of the case body 30 and the case cover 40, which enhances the airtightness of the sealing part 60 and prevents or reduces unnecessary expansion of the outer shape of the case 20. This structure increases the efficiency of the internal space of the case 20 while providing stability in the arrangement of the internal components of battery.

FIG. 13 is a flowchart showing a method for manufacturing the secondary battery 1 according to an embodiment of the present disclosure. As shown in FIGS. 3 to 8 and 13, the method for manufacturing the secondary battery 1 according to an embodiment of the present disclosure includes an action (S10) of preparing a case 20 including a case body 30 that forms a space in which an electrode assembly 10 is accommodated, and a case cover 40 that seals the upper side of the case body 30.

In some examples, the action (S10) of preparing the case body 30 and the case cover 40 may include an action of forming a structure in which the case cover 40 is integrally connected to the case body 30. The structure in which the case body 30 and the case cover 40 are connected may be designed to increase precision between parts during the assembling process and to reduce errors that may occur during the sealing process.

The present method includes an action (S20) of inwardly folding the sealing part 60 positioned on both sides (a first side and a second side) in the width direction (x) of the case body 30 and the case cover 40 to the case 20. In some examples, the action of inwardly folding the sealing part 60 may include an action of controlling the folding angle (A1, A2) of the sealing part 60 to be maintained between 90 degrees and 270 degrees. In some embodiments, the cover side folding angle (A1) and the body side folding angle (A2) can each be in a range of approximately 90 degrees to approximately 270 degrees.

In some embodiments, the action of inwardly folding the sealing part 60 may include an action of inwardly folding the first body side 72 positioned on one side in the width direction (x) of the case body 30 and the first cover side 74 positioned on one side in the width direction (x) of the case cover 40, respectively.

In some embodiments, the method includes, an action of inwardly folding the second body side 82 positioned on the other side in the width direction (x) of the case body 30 and the second cover side 84 positioned on the other side in the width direction (x) of the case cover 40.

In some embodiments, the method may include an action (S30) of sealing both sides of the case body 30 and the case cover 40 inwardly folded to the interior of the case 20 in the width direction (x) to form a sealing part 60. The case body 30 and the case cover 40 may be formed of a polymer film, and the sealing part 60 may be sealed by a heat compression method, an ultrasonic vibration method, or a combination thereof.

In some examples, the action of sealing the sealing part 60 may include an action of applying an adhesive reinforcing agent 90 to the inside of the folded portion of the sealing part 60 and then curing the same. Utilizing the adhesive reinforcing agent 90 can increase the sealing strength of the sealing part 60 and prevent airtightness degradation due to micro-gaps.

In some embodiments, the action of sealing the sealing part 60 may include a double folding process in which the sealing part 60 is folded once and then additionally folded (e.g., refolded). The double folding process can reduce the overall length of the sealing part 60 to help increase the internal space utilization of the case 20, and further improve the structural strength and airtightness of the sealing part 60.

The sealing process can be performed by using automated equipment, reducing the process time and ensuring consistent seal quality. For the thermal compression method, a constant pressure may be applied via a hot plate and rollers to facilitate bonding of the polymer film. For the ultrasonic vibration method, ultrasonic vibration energy may be used to induce local melting of the film, forming the sealing part 60.

After the sealing process, a quality inspection action may check the folded state of the sealing part 60, so that the airtightness and structural reliability of the sealing part 60 can be confirmed.

After inserting the electrode assembly 10 through the opening part 50 of the case 20, an action (S40) of sealing the opening part 50 is included. In some examples, the action of sealing the opening part 50 may include an action of sealing the opening part 50 by compression using a hot plate and a roller.

In some embodiments, in order to strengthen the adhesion of the part in contact with the inside of case 20 during the sealing process, a process of additionally applying or curing the adhesive reinforcing agent 90 may be included.

The manufacturing method of an embodiment of the present disclosure can efficiently utilize the internal space of the case 20, provide high precision in the assembling and sealing process, and enhance the durability and performance of battery.

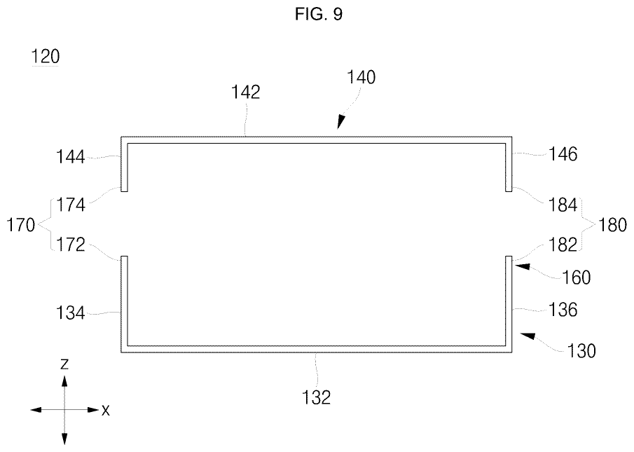

FIG. 9 is a cross-sectional view of a case body 130 separated from a case cover 140 according to an embodiment of the present disclosure. As shown in FIG. 9, the case 120 according to an embodiment of the present disclosure may include a case body 130 and a case cover 140.

In one embodiment, the case body 130 and the case cover 140 may be formed as an integral structure in which one side in the length direction (y) is connected, and this structure can provide the effect of improving the assembling precision of the case 120 and reducing errors that may occur during the sealing process.

The case body 130 has a box shape that forms a space for accommodating the electrode assembly 10, and has an open upper side. The case body 130 may include a base surface 132, a first body side surface 134, and a second body side surface 136. The base surface 132 has a flat shape, and the first body side surface 134 is connected to one side in the width direction (x), and the second body side surface 136 is connected to the other side in the width direction (x). The first body side surface 134 and the second body side surface 136 extend in the up-down direction (z), and the upper portions of each may form the first body side 172 and the second body side 182 of the sealing part 160.

The case cover 140 has an open bottom structure, and an inner space surrounding the upper portion of the electrode assembly 10 can be formed therein. The case cover 140 may include a cover surface 142, a first cover side surface 144, and a second cover side surface 146. The cover surface 142 has a flat shape, and the first cover side surface 144 is connected to one side in the width direction (x), and the second cover side surface 146 is connected to the other side in the width direction (x). The first cover side surface 144 and the second cover side surface 146 extend in the up-down direction (z), and the lower portions of each can form the first cover side 174 and the second cover side 184 of the sealing part 160.

The sealing part 160 may be formed through a structure in which the case body 130 and the case cover 140 are inwardly folded to the interior of the case 120. The sealing part 160 includes a first adhesion part 170 and a second adhesion part 180, which are respectively positioned on one side and the other side in the width direction (x) of the case 120. The first adhesion part 170 is formed by folding and sealing the first body side 172 and the first cover side 174, and the second adhesion part 180 is formed by folding and sealing the second body side 182 and the second cover side 184.

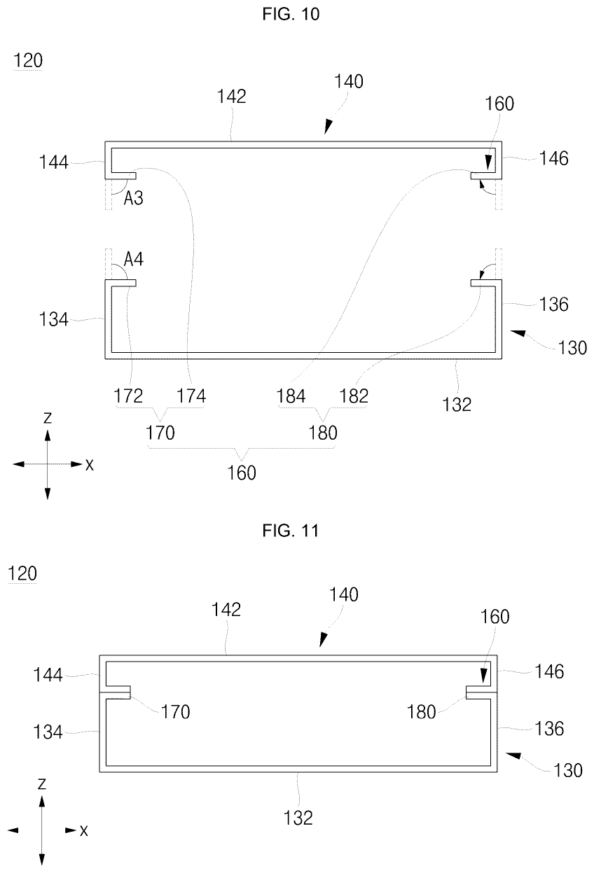

FIG. 10 is a cross-sectional view of the case body 130 and the case cover 140 folded on both sides in the width direction (x), according to an embodiment of the present disclosure. As shown in FIG. 10, the first body side 172 and the first cover side 174 may be inwardly folded to the interior of the case 120, and the folding angle (A4) of the first body side 172 and the folding angle (A3) of the first cover side 174 may be maintained between 90 degrees and 270 degrees, respectively. In some embodiments, the second body side 182 and the second cover side 184 may also be inwardly folded to the interior of the case 120 and have the same folding angle (A3, A4).

That is, the folding angles (A4) of the first body side 172 and the second body side 182 may be similar or the same. In some embodiments, the folding angles (A3) of the first cover side 174 and the second cover side 184 may be similar or the same.

The folding angles (A3, A4) increase the utilization of the internal space of the case 120 by stably inwardly folding the case body 130 and the case cover 140 and tightly sealing the same, and by appropriately controlling the folding angles (A3, A4), the airtightness and structural durability of the sealing part 160 can be further improved.

The sealing part 160 may be formed through a heat-sealing method, an ultrasonic vibration method, or an adhesive method. In particular, the ultrasonic vibration method enables fast and uniform sealing while reducing heat damage.

FIG. 11 is a cross-sectional view of a first adhesion part 170 and a second adhesion part 180 inside a case 120, according to an embodiment of the present disclosure. As shown in FIG. 11, when the case cover 140 is lowered and comes into contact with the case body 130, the first body side 172 and the first cover side 174 are brought into close contact and sealed, and the first adhesion part 170 is formed. Similarly, the second body side 182 and the second cover side 184 may also come into contact and be sealed, and the second adhesion part 180 may be formed.

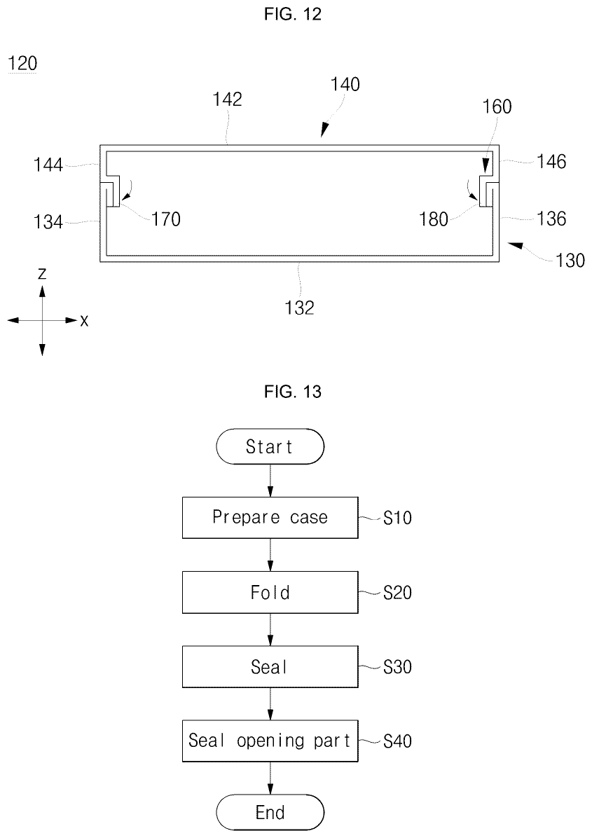

FIG. 12 is a cross-sectional view of the first adhesion part 170 and the second adhesion part 180 inwardly folded to the interior of the case 120, according to an embodiment of the present disclosure. As shown in FIG. 12, the first adhesion part 170 may be folded along the first body side surface 134 or the first cover side surface 144, and the second adhesion part 180 may be folded along the second body side surface 136 or the second cover side surface 146.

In some embodiments, a double folding process may be applied. Double folding can contribute to increasing space utilization by reducing the length of the sealing part 160, while further enhancing sealing strength. After double folding, an adhesive reinforcing agent may be applied to the sealing part 160 and cured to perform additional sealing. This improves the airtightness of the sealing part 160 and effectively prevents or reduces the infiltration of external substances into the battery.

An embodiment of the present invention can provide the effect of improving the airtightness of the battery while increasing the internal space utilization through the folding structure and sealing treatment of the sealing part 160.

The electrode assembly 10 of the present invention will be described in more detail.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c}(0.90≤a≤1.8, 0≤b≤0.5, 0≤c≤0.05); LiₐMn_{2-b}X_{b}O_{4-c}D_{c}(0.90≤a≤1.8, 0≤b≤0.5, 0≤c≤0.05); LiₐNi_{1-b-c}Co_{b}X_{c}O_{2-α}D_{α}(0.90≤a≤1.8, 0≤b≤0.5, 0≤c≤0.5, 0<α<2); LiₐNi_{1-b-c}Mn_{b}X_{c}O_{2-α}D_{α}(0.90≤a≤1.8, 0≤b≤0.5, 0≤c≤0.5, 0<α<2); LiₐNi_{b}Co_{c}L¹_{d}GₑO₂(0.90≤a≤1.8, 0≤b≤0.9, 0≤c≤0.5, 0≤d≤0.5, 0≤e≤0.1); LiₐNiG_{b}O₂(0.90≤a≤1.8, 0.001≤b≤0.1); LiₐCoG_{b}O₂(0.90≤a≤1.8, 0.001≤b≤0.1); LiₐMn_{1-b}G_{b}O₂(0.90≤a≤1.8, 0.001≤b≤0.1); LiₐMn₂G_{b}O₄(0.90≤a≤1.8, 0.001≤b≤0.1); LiₐMn_{1-g}G_{g}PO₄(0.90≤a≤1.8, 0≤g≤0.5); Li_{(3-f)}Fe₂(PO₄)₃(0≤f≤2); LiₐFePO₄(0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The current collector may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOx (0<x<2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The separator may include a porous substrate and a coating layer including an organic material, an inorganic material, or a combination thereof on one or both surfaces of the porous substrate.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer containing an organic material and a coating layer containing an inorganic material that are laminated on each other.

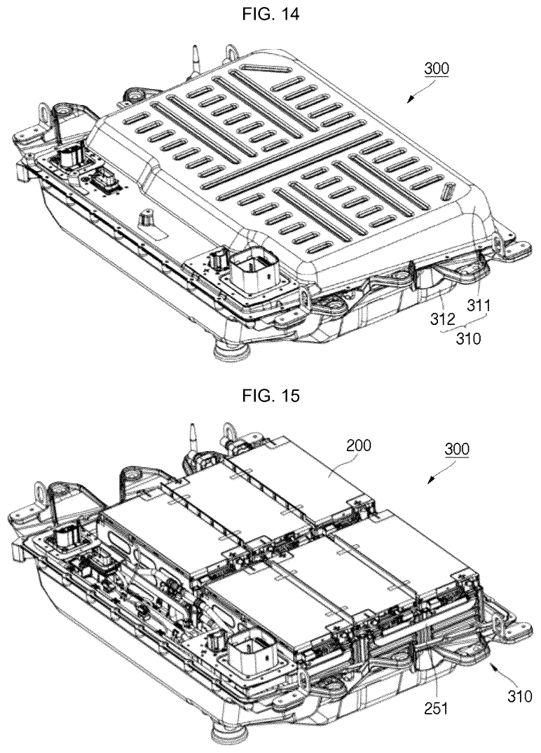

The batteries according to the above-described embodiments may be used to manufacture a battery pack. FIGS. 14 and 15 are perspective views showing a battery pack including the exemplary secondary battery according to the present disclosure. Referring to FIGS. 14 and 15, the battery pack 300 may include a plurality of battery modules 200 and a housing 310 to accommodate the plurality of battery modules 200. For example, the housing 310 may comprise a first and a second housing 311, 312 that are coupled in facing directions with the plurality of battery modules 200 interposed between them. The plurality of battery modules 210 can be electrically connected to each other using a bus bar 251, and the plurality of battery modules 200 can be electrically connected in series/parallel or a mixed series-parallel manner to obtain the required electrical output. In the drawings, for the sake of convenience, components such as bus bars, cooling units, and external terminals for the electrical connection of battery cells are omitted. In some embodiments, the battery pack 300 can be mounted on a vehicle. The vehicle may be, for example, an electric vehicle, a hybrid vehicle, or a plug-in hybrid vehicle. The vehicle can include both four-wheel and two-wheel vehicles.

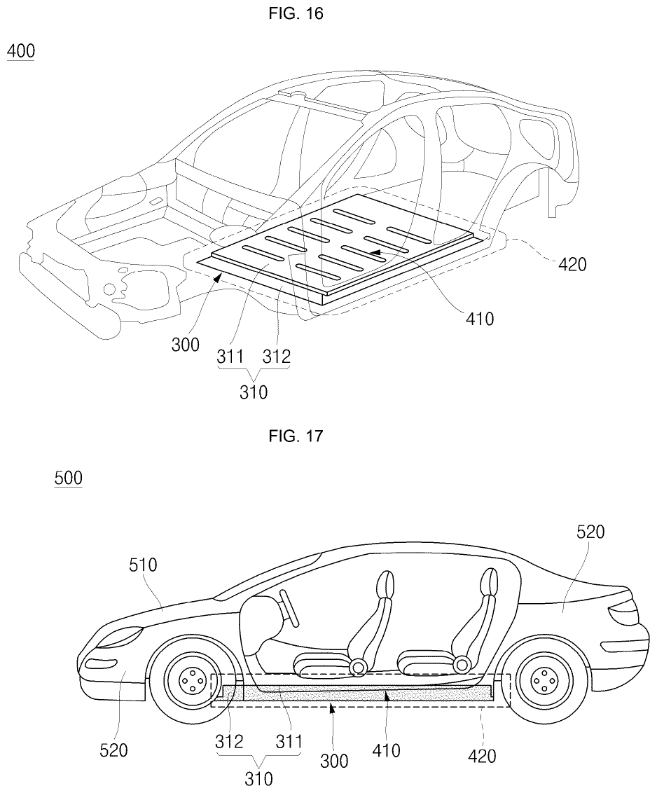

FIGS. 16 and 17 are, respectively, a perspective view and a side view showing vehicles 400 and 500 including the exemplary battery pack 300 according to the present disclosure.

In FIG. 16, the battery pack 300 may include a battery pack cover 311, which is part of the vehicle underbody 410 and may correspond to the first housing, and a pack frame 312, which is placed beneath the vehicle underbody 410 and may correspond to the second housing. The battery pack cover 311 and pack frame 312 may be structurally integrated with the vehicle floor 420. The vehicle underbody 410 separates the interior and exterior of the vehicle, and the pack frame 312 may be positioned outside the vehicle.

As shown in FIG. 17, the vehicle 500 can be assembled with additional components such as a hood 510 at the front of the vehicle body 400 and fenders 520 located at the front and rear of the vehicle. The vehicle 500 includes the battery pack 300 comprising the battery pack cover 311 and the pack frame 312, and the battery pack 300 can be coupled to the vehicle body part 400.

Although a few embodiments of the present disclosure have been shown and described, it would be appreciated by those skilled in the art that various changes and modifications may be made in this embodiment without departing from the principles and technical idea of the disclosure.

What is claimed is:

1. A secondary battery comprising:
an electrode assembly; and
a case accommodating the electrode assembly,
wherein the case includes a case body that forms a space in which the electrode assembly is accommodated and a case cover on an upper side of the case body, and a sealing part on a first side and a second side in the width direction of the case body and the case cover inwardly folded to the interior of the case for sealing the case body and the case cover.

2. The secondary battery as claimed in claim 1, wherein the sealing part is positioned between the electrode assembly and the inner wall of the case body.

3. The secondary battery as claimed in claim 1, wherein the sealing part is formed by inwardly folding a first edge and a second edge in the width direction of the case, wherein the case cover is in contact with the case body.

4. The secondary battery as claimed in claim 1, wherein the case body and the case cover are formed of a polymer film.

5. The secondary battery as claimed in claim 1, wherein the sealing part includes an adhesive reinforcing agent on the inwardly folded portion of the sealing part, wherein the adhesive reinforcing agent is configured to be cured after the case body and the case cover are sealed.

6. The secondary battery as claimed in claim 1, wherein the sealing part comprises:
a first adhesion part positioned on the first side in the width direction of the case; and
a second adhesion part positioned on the second side in the width direction of the case.

7. The secondary battery as claimed in claim 6, wherein the first adhesion part comprises:
a first body side positioned on the first side in the width direction of the case body; and
a first cover side positioned on the first side in the width direction of the case cover,
wherein, the first body side and the first cover side are inwardly folded to the interior of the case for being sealed.

8. The secondary battery as claimed in claim 6, wherein the second adhesion part comprises:
a second body side positioned on the second side in the width direction of the case body; and
a second cover side positioned on the second side in the width direction of the case cover,
wherein, the second body side and the second cover side are inwardly folded to the interior of the case for being sealed.

9. The secondary battery as claimed in claim 6, wherein the first adhesion part and the second adhesion part are inwardly folded once to the interior of the case.

10. The secondary battery as claimed in claim 6, wherein the first adhesion part and the second adhesion part are inwardly folded twice toward the interior of the case.

11. A method for manufacturing a secondary battery, the method comprising:
preparing a case comprising a case body accommodating an electrode assembly and a case cover sealing an upper side of the case body;
inwardly folding to the interior of the case, a first side of the case body and the case cover and a second side of the case body and the case cover, wherein the first side and the second side are in the width direction of the case body and the case cover;
sealing the inwardly folded first side of the case body and the case cover and the inwardly folded second side of the case body and the case cover and forming a sealing part; and
inserting the electrode assembly through an opening part of the case and sealing the opening part.

12. The method as claimed in claim 11, wherein the case body and case cover are made of a polymer film, and the sealing part is sealed through a heat-compression method.

13. The method as claimed in claim 11, wherein the sealing part is sealed by using ultrasonic vibration.

14. The method as claimed in claim 11, wherein the forming of the sealing part comprises applying an adhesive reinforcing agent to the inwardly folded first side and the inwardly folded second side, and curing the adhesive reinforcing agent to additionally seal the case.

15. The method as claimed in claim 11, wherein the inwardly folding the first side and the second side comprises folding the first side and the second side once, and refolding the folded first side and the folded second side.

16. The method as claimed in claim 11, wherein the preparing the case body and the case cover comprises forming a structure in which the case cover is integrally connected to the case body.

17. The method as claimed in claim 11, wherein the sealing the opening part after inserting the electrode assembly into the opening part of the case comprises sealing the opening part by a pressing method using a hot plate and a roller.

18. The method as claimed in claim 11, wherein the inwardly folding the first side and the second side comprises controlling a folding angle of the first side and the second side to be maintained in a range from approximately 90 degrees to approximately 270 degrees.

19. The method as claimed in claim 11, wherein the inwardly folding comprises folding, to the inside of the case, a first body side positioned on the first side in the width direction of the case body and a first cover side positioned on the first side of the width direction of the case cover, respectively.

20. The method as claimed in claim 11, wherein the inwardly folding comprises folding, to the inside of the case, a second body side positioned on the second side in the width direction of the case body and a second cover side positioned on the second side in the width direction of the case cover.
